(19) United States
(12) Patent Application Publication
(10) Pub. No.: US 2011/0217926 A1
(43) Pub. Date: Sep. 8, 2011

(54) REVERSE LINK SIGNALING VIA IMPEDANCE MODULATION

(75) Inventors: Zhen Ning Low, La Jolla, CA (US); Sergio P. Estrada, San Diego, CA (US)

(73) Assignee: QUALCOMM INCORPORATED, San Diego, CA (US)

(21) Appl. No.: 12/905,938

(22) Filed: Oct. 15, 2010

Related U.S. Application Data
(60) Provisional application No. 61/310,243, filed on Mar. 3, 2010.
(60) Provisional application No. 61/328,983, filed on Apr. 28, 2010.

(51) Int. Cl. H04B 5/00

(52) U.S. Cl. 455/41.1

(57) ABSTRACT

Exemplary embodiments are directed to reverse-link signaling via modification of an impedance on the receiver as detected by a transmitter. A method may include receiving a signal from a transmitter at a receiver unit. The method may further include adjusting an impedance detectable by the transmitter by modifying a load coupled with the receiver unit.

### CLAIM OF PRIORITY UNDER 35 U.S.C. §119

This application claims priority under 35 U.S.C. §119(e) to:

U.S. Provisional Patent Application 61/310,243 entitled “WIRELESS POWER RECEIVER CLOAKING AND REVERSE SIGNALING” filed on Mar. 3, 2010, and U.S. Provisional Patent Application 61/328,983 entitled “WIRELESS POWER RECEIVER CLOAKING AND REVERSE SIGNALING” filed on Apr. 28, 2010, the disclosures of which are hereby incorporated by reference in their entirety.

### BACKGROUND

1. Field

The present invention relates generally to reverse link signaling, and more specifically, to systems, device, and methods for impedance variation for reverse link signaling.

2. Background

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2 m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

As will be understood by a person having ordinary skill in the art, a first device, such as a wireless power receiver, may communicate with one or more another device, such as a wireless power transmitter. This communication may be referred to as “reverse link signaling.” As further understood by a person having ordinary skill in the art, signal swing inadequacies may limit conventional methods of reverse link signaling.

A need exists to enhance reverse link signaling. More specifically, a need exists for systems, device, and methods to improve reverse link signaling by enhancing the signal swing of a reverse link signal.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 illustrates a system including a transmitter and a receiver, in accordance with an exemplary embodiment of the present invention.

FIG. 6A illustrates a receiver in a receiving state, according to an exemplary embodiment of the present invention.

FIG. 6B illustrates a receiver in another receive state, according to an exemplary embodiment of the present invention.

FIG. 6C illustrates a configuration of a receiver, according to an exemplary embodiment of the present invention.

FIG. 7 is a more detailed illustration of a system including a transmitter and a receiver, according to an exemplary embodiment of the present invention.

FIG. 8 is an illustration of another system including a transmitter and a receiver, in accordance with an exemplary embodiment of the present invention.

FIG. 9 is a flowchart illustrating a method, in accordance with an exemplary embodiment of the present invention.

FIG. 10 is a flowchart illustrating another method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The term “wireless power” is used herein to mean any form of energy associated with electric fields, magnetic fields, electromagnetic fields, or otherwise that is transmitted between a transmitter to a receiver without the use of physical electrical conductors.

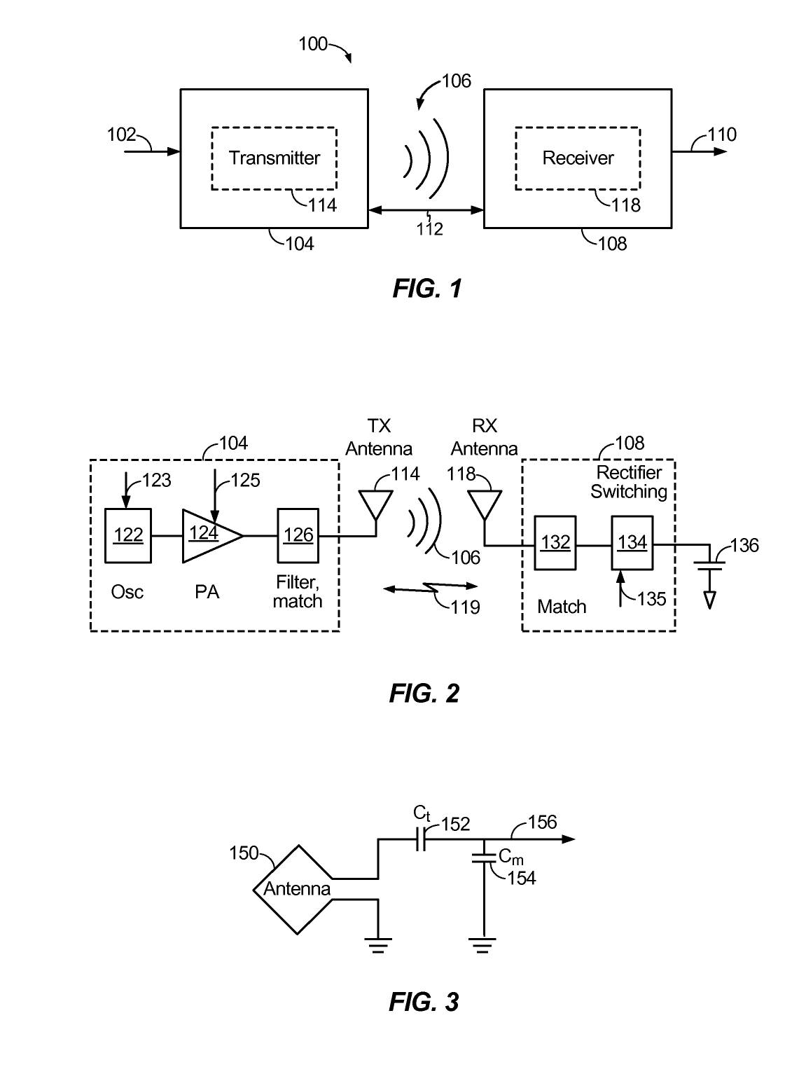

FIG. 1 illustrates a wireless transmission or charging system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system. The transmitter 104 includes an oscillator 122, a power amplifier 124 and a filter and matching circuit 126. The oscillator is configured to generate a signal at a desired frequency, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

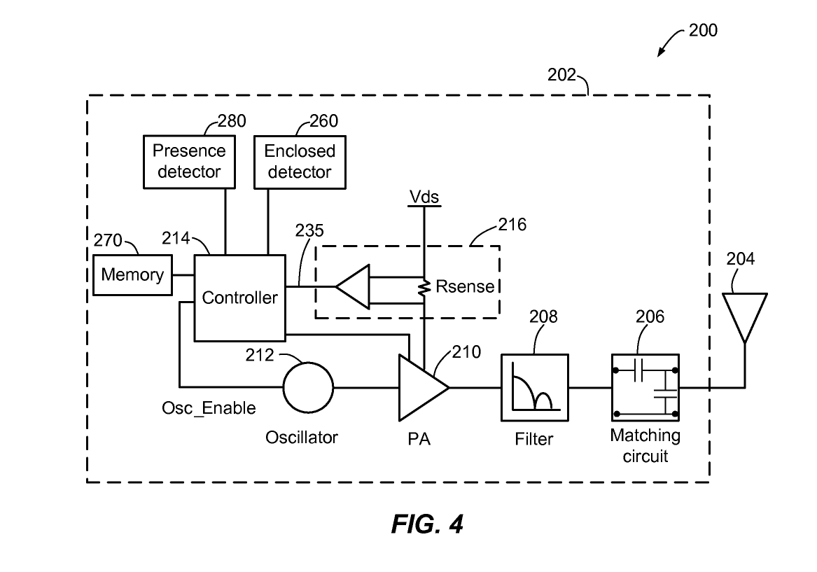

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. It is noted that transmitter 200 may operate at any suitable frequency. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current drawn by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 further includes a controller 214 for enabling the oscillator 212 during transmit phases (or duty cycles) for specific receivers, for adjusting the frequency or phase of the oscillator, and for adjusting the output power level for implementing a communication protocol for interacting with neighboring devices through their attached receivers. As is well known in the art, adjustment of oscillator phase and related circuitry in the transmission path allows for reduction of out of band emissions, especially when transitioning from one frequency to another.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy and to communicate with an active receiver.

Transmit antenna 204 may be implemented with a Litz wire or as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency. In an exemplary application where the transmit antenna 204 may be larger in diameter, or length of side if a square loop, (e.g., 0.50 meters) relative to the receive antenna, the transmit antenna 204 will not necessarily need a large number of turns to obtain a reasonable capacitance.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

Various exemplary embodiments of the present invention, as described herein, relate to systems, devices, and methods for reverse link signaling. More specifically, various exemplary embodiments described herein include methods, systems, and devices for varying an impedance of a receiver. Accordingly, an impedance as seen by a transmitter may be varied, which may enable for reverse link signaling from a receiver to a transmitter. Although various exemplary embodiments disclosed herein are described in the context of a wireless power system, the embodiments of the present invention are not so limited. Rather, the embodiments of the present invention may be implemented within any suitable electronic system.

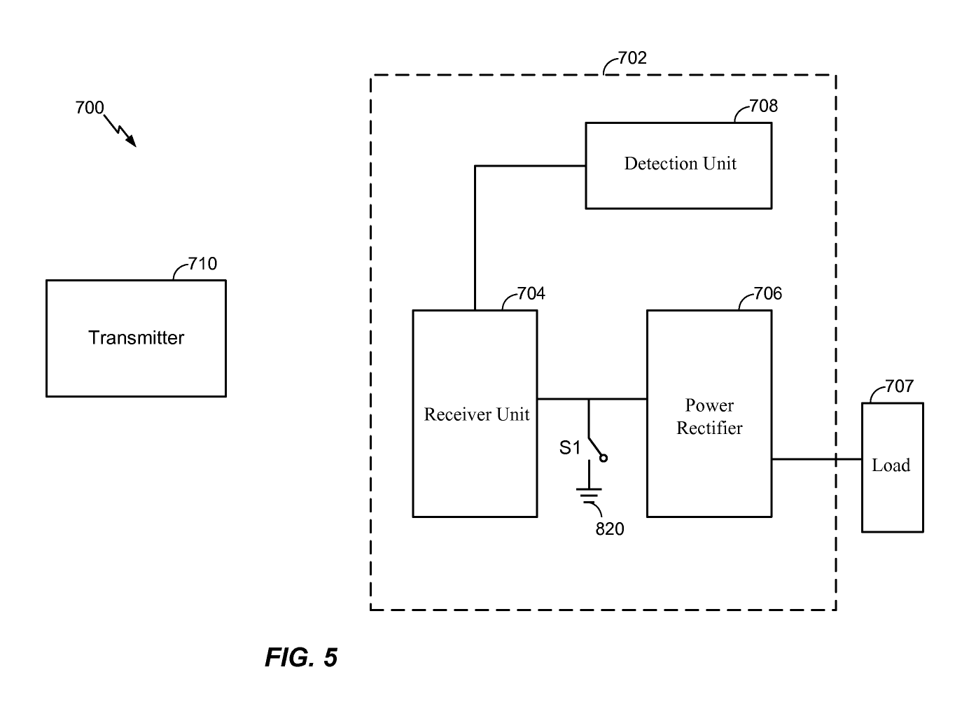

FIG. 5 illustrates a block diagram of a system 700 including a receiver 702, in accordance with an exemplary embodiment of the present invention. Receiver 702 includes a receiver unit 704, a power rectifier 706, and a forward link detection unit 708, which is configured to detect a signal (i.e., a transmit signal) transmitted from a transmitter. Receiver unit 704 may be operably coupled to forward link detection unit 708 and a load 707 may be coupled to receiver 702. Furthermore, receiver unit 704 may be coupled to power rectifier 706. Receiver 702 may also include a switch S1, which may comprise any suitable switching element, such as a transistor. Switch S1 may be configured to selectively couple a node A to a ground voltage 820. Although switch 51 is illustrated as being positioned between receiver unit 704 and power rectifier 706, embodiments of the present invention are not so limited. Rather, switch 51 may be located in any suitable position, such as between power rectifier 706 and load 707. Moreover, although power rectifier 706 and load 707 are illustrated in FIG. 5 as separate elements, the term “load” as used herein may include a power rectifier.

System 700 may further include a transmitter 710 configured to wirelessly transmit power within an associated near field region. It is noted that a reverse link signaling may be generated by modifying the state of switch S1 to change an impedance as detected by transmitter 710. It is further noted that a coil within transmitter 710 and a coil within receiver unit 704 may be tuned with one another to enable for efficient wireless transfer between transmitter 710 and receiver 702. Accordingly, transmitter 710 may also be referred to herein as a “series tuned transmitter.” Similarly, receiver unit 704 may also be referred to herein as a “series tuned receiver.” Transmitter 710 and receiver unit 704 may be commonly referred to herein as “series tuned transceiver system.”

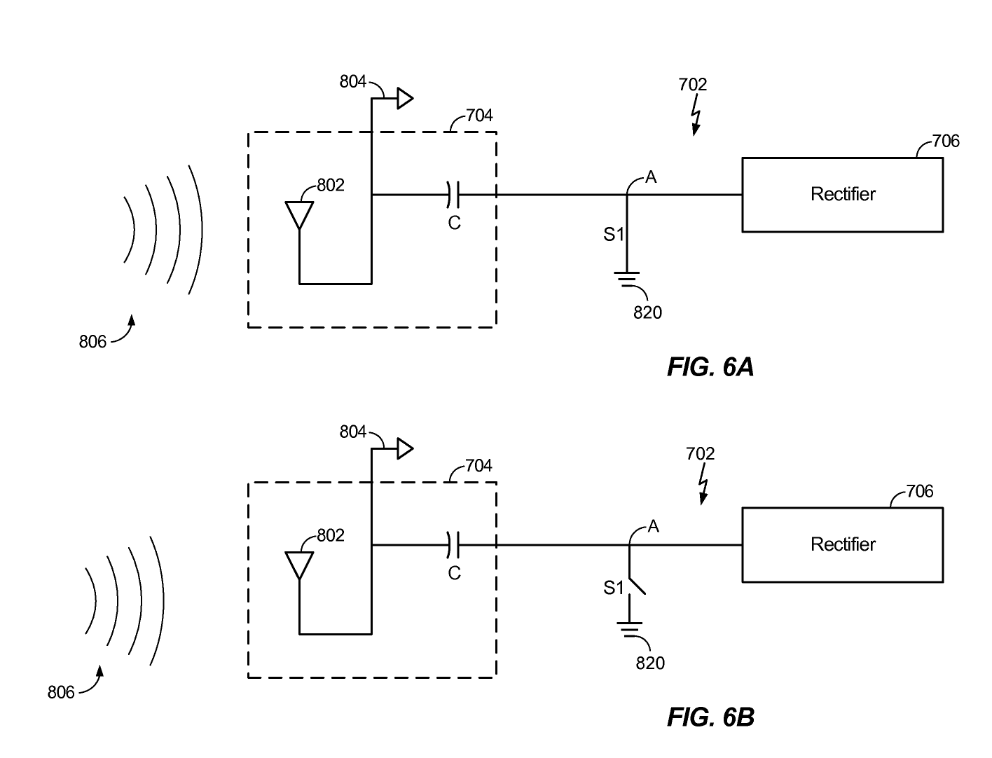

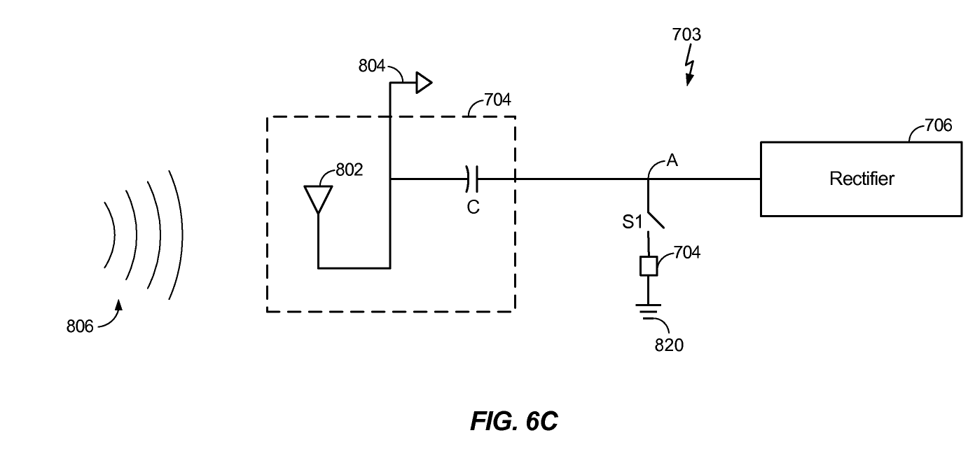

FIGS. 6A and 6B show a schematic of a portion of receiver 702 in various states to illustrate reverse-link signaling from receiver 702 to an associated transmitter (e.g., transmitter 710 of FIG. 5), in accordance with an exemplary embodiment of the present invention. With reference to FIG. 6A, switch 51 is closed and, therefore, node A is coupled to ground voltage 820. With reference to FIG. 6B, switch S2 is open, thus, node A is decoupled from ground voltage 820. As explained more fully below, in comparison to an impedance as seen by transmitter 710 (see FIG. 5) when node A is coupled to a ground voltage, an impedance as seen by transmitter 710 when node A is decoupled from the ground voltage may be lower. Stated another way, an impedance as seen by a transmitter in communication with a receiver in the configuration illustrated in FIG. 6B may be higher than an impedance as seen by a transmitter in communication with a receiver in the configuration illustrated in FIG. 6A. Stated yet another way, as a load associated with a receiver increases, an impedance as seen by a transmitter, which is in communication with the receiver, may decrease. Similarly, as a load of a receiver decreases, the impedance as seen by the transmitter may increase.

FIG. 6C illustrates another configuration of a receiver 703, according to an exemplary embodiment of the present invention. As illustrated in FIG. 6C, receiver 703 includes a component 709 coupled between switch 51 and ground voltage 820. Component 709 may comprise a resistor, a capacitor, an inductor, or a combination thereof.

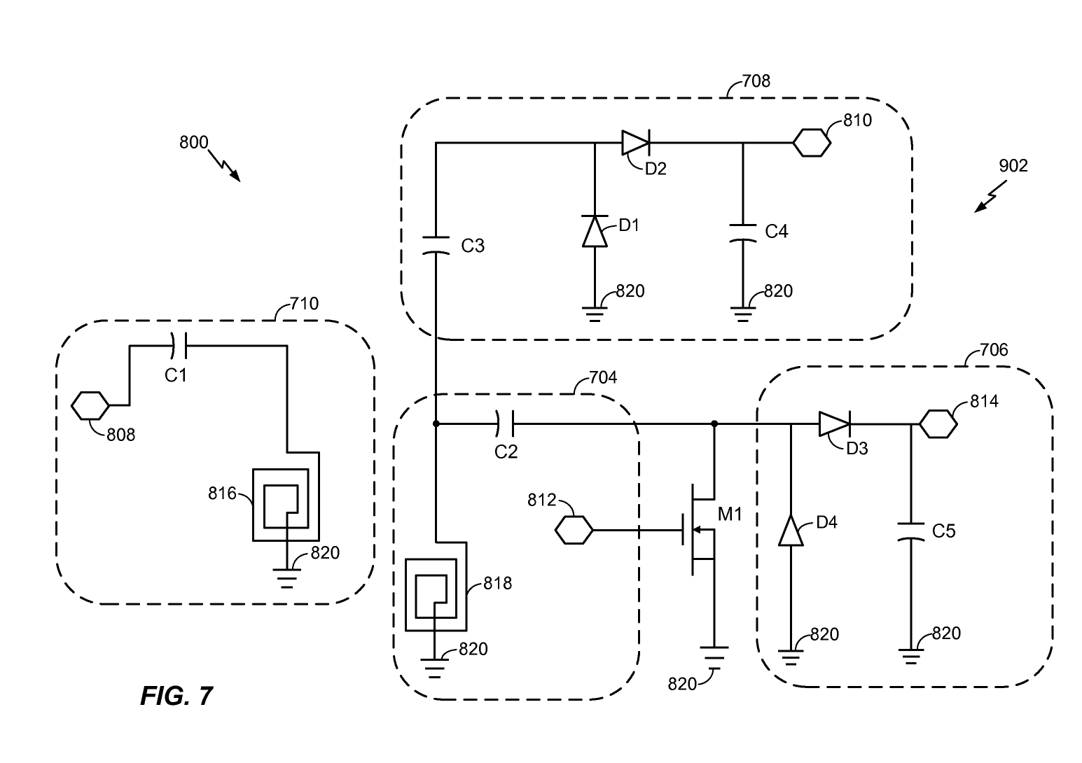

FIG. 7 is a circuit illustration of a system 800 including receiver 902, according to an exemplary embodiment of the present invention. Similarly to system 700 illustrated in FIG. 5, system 800 includes receiver 902 including a receiver unit 904, a power rectifier 906, and a forward link detection unit 908, which is configured to detect a signal transmitted from an associated transmitter. Receiver unit 904 may be operably coupled to forward link detection unit 908. Furthermore, receiver unit 904 may be selectively coupled to power rectifier via transistor M1. System 800 may further include transmitter 710, which, as noted above, may be configured for wirelessly transmitting power within an associated near-field region.

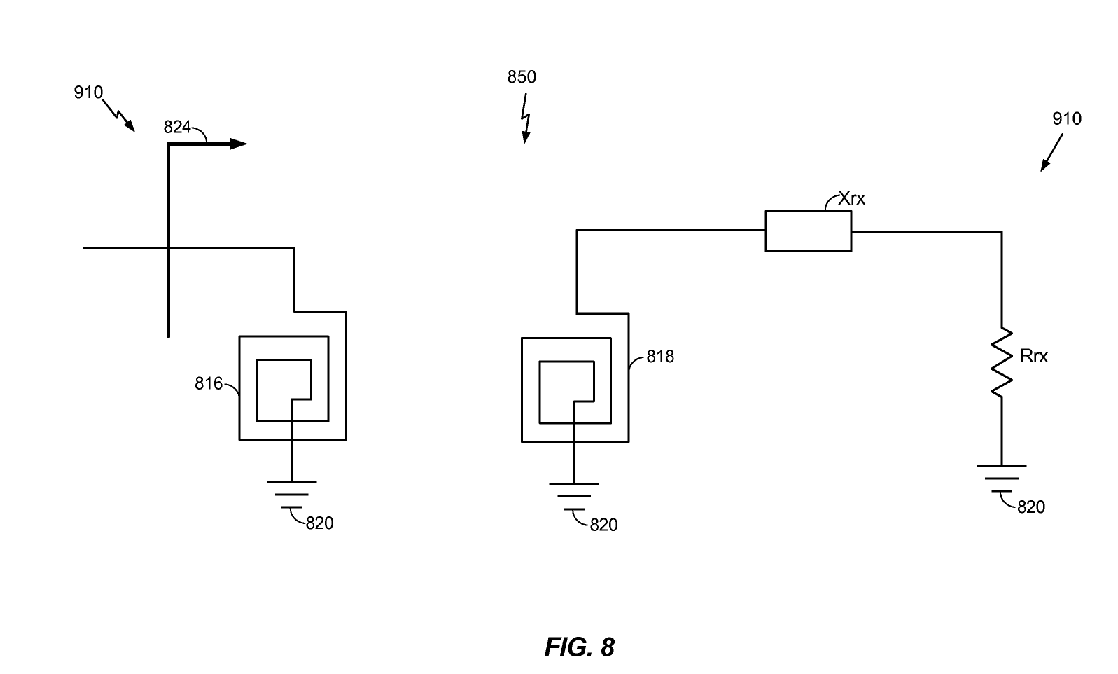

As illustrated in FIG. 7, forward link detection unit 908 comprises capacitors C3 and C4, diodes D1 and D2, and an output 810. Forward link detection unit 908 is configured receive a signal from receiver unit 904. It is noted that the embodiments of the present invention are not limited to forward link detection unit 908 illustrated in FIG. 8. Rather, forward link detection unit 908 is an example of a forward link detection unit and the embodiments to the present invention may comprise any suitable forward link detection unit.

Receiver unit 904 comprises a receiver coil 818 and a capacitor C2. Receiver unit 904 is selectively coupled to and configured to convey a signal to power rectifier 906. Receiver 902 includes a transistor M1 (i.e., a switching element) having a gate coupled to a control source 812, a source coupled to a ground voltage 820, and a drain coupled to a node 905. As noted above, although system 800 is illustrated as comprising a transistor as a switching element, embodiments of the present invention may include any suitable type switching element. Furthermore, a component (e.g., a resistor, an inductor, a capacitor, or a combination thereof) may be coupled between the switching element and ground voltage 820. As illustrated, node 905 is coupled between an output of receiver unit 904 and an input of power rectifier 906. It is noted that the embodiments of the present invention are not limited to receiver unit 904 illustrated in FIG. 8. Rather, receiver unit 904 is an example of a receiver unit and the embodiments to the present invention may comprise any suitable receiver component.

As will be appreciated by a person having ordinary skill in the art, while transistor M1 is in a non-conductive state, power rectifier 906 may receive a signal from receiver unit 904. Furthermore, while transistor M1 is in a conductive state, the output of receiver unit 904 will be shorted to ground voltage 820 and, therefore, power rectifier 906 may not receive a signal from receiver unit 904.

Power rectifier 906 comprises diodes D3 and D4, capacitor C5, and an output 814, which may be coupled to a load, such as load 707 illustrated in FIG. 5. Power rectifier 906 is selectively coupled to and configured to receive a signal from receiver unit 904. It is noted that the embodiments of the present invention are not limited to power rectifier 906 illustrated in FIG. 8. Rather, power rectifier 906 is an example of a power rectifier and the embodiments to the present invention may comprise any suitable power rectifier.

Transmitter 710 comprises a transmitter coil 816 and a capacitor C1. Transmitter 710 further comprises an input 808, which may be configured to receive a signal from a power amplifier (not shown). It is noted that transmitter 710 and receiver unit 904 may be tuned with one another to enable for efficient wireless transfer between transmit coil 816 and receive coil 818. Accordingly, as noted above, transmitter 710 may comprise a series tuned transmitter. Similarly, receiver unit 904 may comprise a series tuned receiver. Furthermore, transmitter 710 and receiver unit 904 together may comprise a series tuned transceiver system.

It is noted that, in comparison to an impedance as seen by transmitter 710 when receiver unit 904 is coupled to rectifier 906, an impedance as seen by transmitter 710 when receiver unit 904 is decoupled from rectifier 906 may be larger. Stated another way, an impedance as seen by a transmitter in communication with a receiver in a configuration in which transistor M1 is in a conductive state may be higher than an impedance as seen by a transmitter in communication with a receiver in a configuration in which transistor M1 is in a non-conductive state. Stated yet another way, as a load of a receiver increases, an impedance as seen by a transmitter may decrease. Similarly, as a load of a receiver decreases, the impedance as seen by a transmitter may increase.

FIG. 8 illustrates a system 850 including portion of a transmitter 910 including transmitter coil 816 and a portion of a receiver 952 including a receiver coil 818. Receiver further includes an imaginary load Xᵣₓ and a real load R. An impedance Zₜₓ, which is illustrated by arrow 824, as seen by transmitter 910 and associated with receiver 952 may be given by the following equation:

$${Z}_{tx} = \frac{{w}^{2} {M}_{12}^{2} {R}_{rx}}{{R}_{rx}^{2} + {( {wM}_{22} + {X}_{rx} )}^{2}} + j [ {wM}_{11} - \frac{{w}^{2} {M}_{12}^{2} ( {wM}_{22} + {X}_{rx} )}{{R}_{rx}^{2} + {( {wM}_{22} + {X}_{rx} )}^{2}} ] \qquad ( 1 )$$

wherein Zₜₓ is the impedance looking into the transmitting coil, ω is the frequency in radians, M₁₁ is the self inductance of transmitting coil 816, M₂₂ is the self inductance of receiving coil 818, M₁₂ is the mutual inductance between transmitting coil 816 and receiving coil 818, Rᵣₓ is the real load of the receiver, and Xᵣₓ is the imaginary load of the receiver.

Furthermore, if transmitter coil 816 and receiver coil 818 are tuned with one another, as previously noted, the impedance Zₜₓ as seen by transmitter 910 and associated with receiver 950 may be given by:

$${Z}_{tx} = \frac{{ω}^{2} {M}_{12}^{2}}{{R}_{rx}} \qquad ( 2 )$$

With reference to FIGS. 5-8 and equation (2), a person having ordinary skill in the art would understand that the impedance Zₜₓ as seen by a transmitter and associated with a receiver may be minimized by maximizing the real load of the receiver Rᵣₓ, and the impedance Zₜₓ may be maximized by minimizing the real load of the receiver Rᵣₓ. Accordingly, with specific reference to FIG. 7, while transistor M1 is in a non-conductive state, power rectifier 906 may receive a signal from receiver unit 904. Furthermore, while transistor M1 is in a conductive state, the output of receiver unit 904 will be shorted to ground voltage 820 and, therefore, power rectifier 904 may not receive a signal from receiver unit 904.

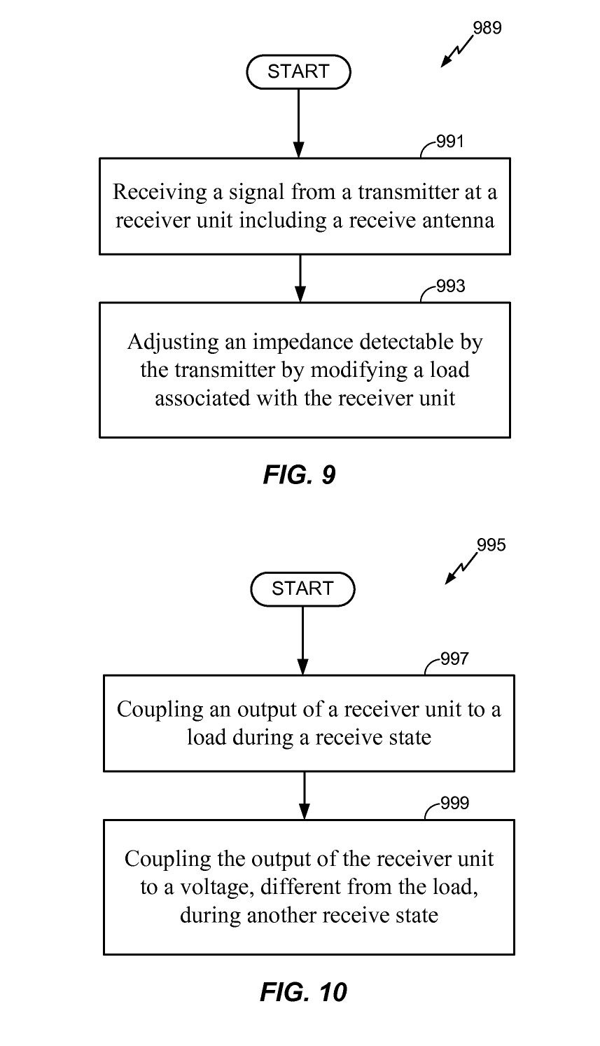

FIG. 9 is a flowchart illustrating another method 989, in accordance with one or more exemplary embodiments. Method 989 may include receiving a signal from a transmitter at a receiver unit including a receive antenna (depicted by numeral 991). Method 989 may further include adjusting an impedance detectable by the transmitter by modifying a load associated with the receiver unit (depicted by numeral 993).

FIG. 10 is a flowchart illustrating another method 995, in accordance with one or more exemplary embodiments. Method 995 may include coupling an output of a receiver unit to a load during a receive state (depicted by numeral 997). Method 995 may further include coupling the output of the receiver unit to a voltage, different than the load, during another receive state (depicted by numeral 999).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method, comprising:
receiving a signal from a transmitter at a receiver unit; and
adjusting an impedance detectable by the transmitter by modifying a load coupled with the receiver unit.

2. The method of claim 1, wherein modifying a load comprises selectively coupling an output of the receiver unit to a ground voltage.

3. The method of claim 1, wherein modifying a load comprises selectively coupling an output of the receiver unit to a ground voltage via at least one of a resistor, a capacitor, and an inductor.

4. The method of claim 3, wherein selectively coupling an output of the receiver unit to a ground voltage comprises selectively coupling the output of the receiver unit to a ground voltage via a transistor.

5. The method of claim 1, wherein modifying a load comprises selectively coupling a node positioned between an output of the receiver unit and an input of a power rectifier to a ground voltage.

6. The method of claim 1, wherein receiving a signal comprises receiving a signal from a transmitter in tune with the receiver unit.

7. A method, comprising:
coupling an output of a receiver unit to a load during a receive state; and
coupling the output of the receiver unit to a voltage, different than the load, during another receive state.

8. The method of claim 7, wherein coupling the output of the receiver unit to a voltage during another receive state comprises coupling the output of the receiver unit to one of a resistor, a capacitor, and an inductor coupled to the voltage.

9. The method of claim 7, wherein coupling an output of a receiver unit to a load comprises coupling the output of the receiver unit to an input of a power rectifier during the receive state.

10. The method of claim 7, wherein coupling the output of the receiver unit to a voltage comprises coupling a node between the output of the receiver unit and an input of a power rectifier to the voltage during the receive state.

11. The method of claim 7, further comprising tuning the receiver unit with an associated transmitter.

12. The method of claim 7, wherein coupling an output of a receiver unit to a voltage comprises causing a transistor coupled between the output of the receiver unit and the voltage to conduct.

13. A receiver, comprising:
a receiver unit configured to receive an RF energy signal; and
a switching circuit coupled to an output of the receiver unit and configured to modify a load coupled with the receiver unit.

14. The receiver of claim 13, wherein the switching circuit comprises a transistor coupled between the output of the receiver unit and a ground voltage.

15. The receiver of claim 14, wherein a drain of the transistor is coupled to each of the output of the receiver unit and the input of a power rectifier.

16. The receiver of claim 14, wherein a source of the transistor is coupled to the ground voltage.

17. The receiver of claim 14, wherein the receive unit comprises a receive coil coupled to a capacitor.

18. The receiver of claim 14, wherein the switching circuit is configured to couple an output of the receiver unit to a power rectifier during a receive state and couple the output of the receiver unit to a ground voltage during another receive state.

19. A device, comprising:
a receiver including a receiver unit; and
a switching element configured to at least one of selectively couple the receiver unit to a load and selectively couple the receiver unit to a ground voltage.

20. The device of claim 19, wherein the switching element is configured to selectively couple the receiver unit to the load during a first phase and selectively couple the receiver unit to a ground voltage during a second phase.

21. The device of claim 19, wherein the switching element is coupled to a resistive component coupled to the ground voltage.

22. The device of claim 19, wherein the switching element comprises a transistor having a drain coupled between the load and the receiver unit and a source coupled to the ground voltage.

23. The device of claim 19, further comprising a power rectifier having an input coupled the switching element.

24. The device of claim 19, wherein the receiver unit further comprises a receive antenna coupled to a capacitor, wherein the transistor is coupled to the capacitor.

25. A device, comprising:
means for receiving a signal from a transmitter at a receiver unit; and
means for adjusting an impedance detectable by the transmitter by modifying a load coupled with the receiver unit.

26. The method of claim 25, wherein the device further comprises means for selectively coupling an output of the receiver unit to a ground voltage.

27. The method of claim 25, wherein the device further comprises means for receiving the signal from a transmitter in tune with the receiving unit.

28. A device, comprising:
means for coupling an output of a receiver unit to a load during a receive state; and
means for coupling the output of the receiver unit to a voltage, different than the load, during another receive state.

29. The method of claim 28, wherein the device further comprises means for coupling a node between the output of the receiver unit and an input of a power rectifier to the ground voltage during the another receive state.

30. The method of claim 28, wherein the device further comprises means for tuning the receiver unit with a transmitter during each of the receive state and the another receive state.
